(19) United States
(12) Patent Application Publication
(10) Pub. No.: US 2024/0406083 A1
(43) Pub. Date: Dec. 5, 2024

(54) MONITORING TERMINAL IDENTIFICATION METHOD AND DEVICE, AND STORAGE MEDIUM

(71) Applicant: Ruijie Networks Co., Ltd., Fuzhou (Fujian) (CN)

(72) Inventor: Zhipeng QIU, Fuzhou, Fujian (CN)

(21) Appl. No.: 18/797,981

(22) Filed: Aug. 8, 2024

(30) Foreign Application Priority Data
Dec. 20, 2022 (CN) 202211644097.0

(51) Int. Cl. H04L 43/04; H04N 7/18

(52) U.S. Cl. CPC H04L 43/04; H04N 7/18

(57) ABSTRACT

The embodiments of the present application relate to the technical field of communications. Disclosed are a monitoring terminal identification method, and a device and a storage medium. In the embodiments of the present application, the method comprises: a cloud server determining that a target port is one of a plurality of ports of a network switch; within N set time windows, continuously performing N times of data monitoring for a data stream transmitted at the target port, so as to obtain corresponding N groups of monitoring results, N being a positive integer; performing comprehensive feature extraction for the N groups of monitoring results, so as to obtain a data feature vector of the data stream; and on the basis of the data feature vector, obtaining a terminal type of a target terminal which is directly connected to the target port.

### CROSS-REFERENCE TO RELATED APPLICATIONS

The present application is a continuation of International Patent Application No. PCT/CN 2023/140313, which claims priority to a Chinese patent application No. 202211644097.0, filed on Dec. 20, 2022, both of which are incorporated herein by reference in their entireties.

### TECHNICAL FIELD

This application relates to the field of communication technologies, and in particular to a surveillance-terminal identification method, a device, and a storage medium.

### BACKGROUND

With the rapid development of digital networks and the increasing awareness of security, more surveillance terminals are being deployed in the network environment. The surveillance terminals mainly include Internet Protocol Cameras (IPC) and Network Video Recorders (NVR) equipped with the IPCs.

### SUMMARY

Exemplary embodiments of this application provide a surveillance-terminal identification method and a related apparatus.

According to a first aspect, an embodiment of this application provides a surveillance-terminal identification method, where the method includes:
determining a target port, where the target port is one of a plurality of ports of a network switch;
performing data monitoring N times in succession on a data flow transmitted through the target port within N set time windows to obtain N sets of corresponding monitoring results, where each set of monitoring results includes at least one traffic status attribute of the data flow, and N is a positive integer;
performing comprehensive feature extraction on the N sets of monitoring results to obtain a data feature vector of the data flow, where the data feature vector represents a traffic distribution of the data flow passing through the target port at different time points within the N time windows; and obtaining, based on the data feature vector, a terminal type of a target terminal directly connected to the target port.

Optionally, the performing comprehensive feature extraction on the N sets of monitoring results to obtain the data feature vector of the data flow includes:
obtaining a preset vector template, where the vector template is used to indicate element types corresponding to a plurality of vector elements included in the data feature vector and an element value calculation method corresponding to each element type;
obtaining, based on the N sets of monitoring results, a plurality of corresponding vector element values respectively using the plurality of element value calculation methods indicated by the vector template; and
obtaining the data feature vector based on the obtained plurality of vector element values.

Optionally, the obtaining, based on the N sets of monitoring results, a plurality of corresponding vector element values respectively using the plurality of element value calculation methods indicated by the vector template includes:
obtaining N sets of statistical results based on the N sets of monitoring results; and
obtaining the corresponding vector element values for the obtained N sets of statistical results, respectively using the element value calculation methods recorded in the vector template.

Optionally, the obtaining N sets of statistical results based on the N sets of monitoring results includes:
determining a time period covered by a time window corresponding to one of the N sets of monitoring results;
obtaining, based on the time period, at least one statistical parameter corresponding to at least one traffic status attribute of a data flow included in the one set of monitoring results; and
using the obtained at least one statistical parameter as the statistical result corresponding to the one set of monitoring results.

Optionally, each set of monitoring results includes: a sum of uplink traffic in a unit time window, a sum of downlink traffic in a unit time window, a quantity of uplink packets in a unit time window, and a quantity of downlink packets in a unit time window.

Optionally, the statistical result includes at least one of the following: an uplink rate, a downlink rate, a ratio of an uplink rate to a downlink rate, a unit uplink packet size, a unit downlink packet size, a ratio of the unit uplink packet size to the unit downlink packet size, and a ratio of a quantity of uplink packets to a quantity of downlink packets.

Optionally, the vector element value includes at least one of the following: an average value feature, a median value feature, a standard deviation feature, an interquartile range median ratio feature, and a coefficient of variation feature.

Optionally, the obtaining, based on the data feature vector, the terminal type of the target terminal directly connected to the target port includes:
inputting the data feature vector into a pre-trained terminal type identification model to obtain a terminal type of the target terminal, where the terminal type identification model is obtained through training based on historical data flows transmitted through a plurality of ports of a plurality of network switches and historical terminal types directly connected to the plurality of ports.

Optionally, the terminal type identification model includes an internet protocol camera IPC identification model and a network video recorder NVR identification model.

Optionally, the inputting the data feature vector into the pre-trained terminal type identification model to obtain the terminal type of the target terminal includes:
inputting the data feature vector into the IPC identification model to obtain an output result Yᵢ^{ipc}; and
in response to Yᵢ^{ipc} being greater than or equal to a first threshold, determining that the terminal type of the target terminal is an internet protocol camera of a surveillance terminal.

Optionally, after the output result Yᵢ^{ipc} is obtained, the method further includes:
in response to Yᵢ^{ipc} being less than the first threshold, inputting the data feature vector into the NVR identification model to obtain an output result Yᵢ^{nvr}; and
in response to Yᵢ^{nvr} being greater than or equal to the first threshold, determining that the terminal type of the target terminal is a network video recorder of the surveillance terminal.

Optionally, after the output result Yᵢ^{nvr} is obtained, the method further includes:
in response to Yᵢ^{nvr} being less the first threshold, determining that the terminal type of the target terminal is another network device other than IPC and NVR.

Optionally, the terminal type identification model is a boosting decision tree model.

Optionally, after the obtaining a terminal type of a target terminal directly connected to the target port, the method further includes:
storing a target port number of the target port and the terminal type of the target terminal to a cloud database.

Optionally, after the storing the target port number of the target port and the terminal type of the target terminal to a cloud database, the method further includes:
storing a serial number of the network switch to which the target port belongs and a MAC address of the target terminal to the cloud database in a corresponding manner.

Optionally, the terminal type of the target terminal is any one of the following:
an IPC of a surveillance terminal;
an NVR of the surveillance terminal; and
another network device other than the IPC and the NVR.

According to a second aspect, an embodiment of this application further provides a surveillance-terminal identification apparatus, where the apparatus includes:
a port selection module, configured to determine a target port, where the target port is one of a plurality of ports of a network switch;
a data monitoring module, configured to perform data monitoring N times in succession on a data flow transmitted through the target port within N set time windows to obtain N sets of corresponding monitoring results, where each set of monitoring results includes at least one traffic status attribute of the data flow, and Nis a positive integer;
a feature extraction module, configured to perform comprehensive feature extraction on the N sets of monitoring results to obtain a data feature vector of the data flow, where the data feature vector represents a traffic distribution of the data flow passing through the target port at different time points within the N time windows; and
a type identification module, configured to obtain, based on the data feature vector, a terminal type of a target terminal directly connected to the target port.

Optionally, in the step of performing comprehensive feature extraction on the N sets of monitoring results to obtain a corresponding data feature vector, the feature extraction module is configured to:
obtain a preset vector template, where the vector template is used to indicate element types corresponding to a plurality of vector elements included in the data feature vector and an element value calculation method corresponding to each element type;
obtain, based on the N sets of monitoring results, a plurality of corresponding vector element values respectively using the plurality of element value calculation methods indicated by the vector template; and
obtain the data feature vector based on the obtained plurality of vector element values.

Optionally, in the step of obtaining, based on the N sets of monitoring results, a plurality of corresponding vector element values respectively using the plurality of obtained element value calculation methods, the feature extraction module is configured to:
obtain N sets of statistical results based on the N sets of monitoring results; and
obtain the corresponding vector element values for the obtained N sets of statistical results, respectively using the element value calculation methods recorded in the vector template.

Optionally, the obtaining N sets of statistical results based on the N sets of monitoring results includes:
determining a time period covered by a time window corresponding to one of the N sets of monitoring results;
obtaining, based on the time period, at least one statistical parameter corresponding to at least one traffic status attribute of a data flow included in the one set of monitoring results; and
using the obtained at least one statistical parameter as the statistical result corresponding to the one set of monitoring results; where
each set of monitoring results includes: a sum of uplink traffic in a unit time window, a sum of downlink traffic in a unit time window, a quantity of uplink packets in a unit time window, and a quantity of downlink packets in a unit time window.

The statistical result includes at least one of the following: an uplink rate, a downlink rate, a ratio of an uplink rate to a downlink rate, a unit uplink packet size, a unit downlink packet size, a ratio of the unit uplink packet size to the unit downlink packets, and a ratio of a quantity of uplink packets to a quantity of downlink packets.

The vector element value includes at least one of the following: an average value feature, a median value feature, a standard deviation feature, an interquartile range median ratio feature, and a coefficient of variation feature.

Optionally, in the step of obtaining, based on the data feature vector, the terminal type of the target terminal directly connected to the target port, the type identification module is configured to:
input the data feature vector into a pre-trained terminal type identification model to obtain a terminal type of the target terminal, where the terminal type identification model is obtained through training based on historical data flows transmitted through a plurality of ports of a plurality of network switches and historical terminal types directly connected to the plurality of ports.

Optionally, the terminal type identification model includes an internet protocol camera IPC identification model and a network video recorder NVR identification model.

Optionally, in the step of the inputting the data feature vector into the pre-trained terminal type identification model to obtain the terminal type of the target terminal, the type identification module is configured to:
input the data feature vector into the IPC identification model to obtain an output result Yᵢ^{ipc}; and
in response to Yᵢ^{ipc} being greater than or equal to a first threshold, determine that the terminal type of the target terminal is an internet protocol camera of a surveillance terminal.

Optionally, after the output result Yᵢ^{ipc} is obtained, the type identification module is further configured to:
in response to Yᵢ^{ipc} being less than the first threshold, input the data feature vector into the NVR identification model to obtain an output result Yᵢ^{nvr}; and
in response to Yᵢ^{nvr} being greater than or equal to the first threshold, determine that the terminal type of the target terminal is a network video recorder of the surveillance terminal.

Optionally, after the output result Yᵢ^{nvr}T is obtained, the type identification module is further configured to:

in response to Yᵢ^{nvr} being less the first threshold, determine that the terminal type of the target terminal is another network device other than IPC and NVR.

Optionally, the terminal type identification model is a boosting decision tree model.

Optionally, after obtaining the terminal type of the target terminal directly connected to the target port, the type identification module is further configured to: store a target port number of the target port and the terminal type of the target terminal to a cloud database.

Optionally, after the storing the target port number of the target port and the terminal type of the target terminal to a cloud database, the type identification module is further configured to:

store a serial number of the network switch to which the target port belongs and a MAC address of the target terminal to the cloud database in a corresponding manner.

Optionally, the terminal type of the target terminal is any one of the following:
an IPC of a surveillance terminal;
an NVR of the surveillance terminal; and
another network device other than the IPC and the NVR.

According to a third aspect, an embodiment of this disclosure provides an electronic device, including: a memory, a processor, and a computer program stored in the memory and capable of running on the processor, where when the computer program is executed by the processor, the foregoing method according to the first aspect is implemented.

According to a fourth aspect, am embodiment of this application provides a computer-readable storage medium, where the computer-readable storage medium has a computer program stored thereon, and when the computer program is executed by a processor, the steps of the method according to any one of the first aspect are implemented.

According to a fifth aspect, an embodiment of this application provides a computer program product, when the computer program product is called by a computer, the computer is enabled to execute the method according to the first aspect.

In the embodiments of this application, a could server determines that a target port is any one of ports of various network switches; performs data monitoring N times in succession on a data flow transmitted through the target port within N set time windows to obtain N sets of corresponding monitoring results, where each set of monitoring results includes at least one traffic status attribute of the data flow; performs comprehensive feature extraction on the N sets of monitoring results to obtain a data feature vector of the data flow, where the data feature vector represents a traffic distribution of the data flow passing through the target port at different time points within the N time windows; and obtains, based on the data feature vector, a terminal type of a target terminal directly connected to the target port.

In this way, when a surveillance terminal is used for data transmission with a switch, its data flow has a stronger stability compared with a data flow transmitted by another terminal device. Monitoring is performed on a data flow of a target port and then feature extraction is performed, so as to identify a surveillance terminal of a target terminal directly connected to a target port, improving the efficiency and accuracy of identifying a surveillance terminal.

Other features and advantages of this application will be set forth later in the specification, and in part will be readily apparent from the specification, or may be understood by implementing this application. Objectives and other advantages of this application may be achieved and obtained by using a structure particularly stated in the written specification, claims, and accompanying drawings.

### BRIEF DESCRIPTION OF DRAWINGS

To describe the technical solutions in the embodiments of this application or the prior art more clearly, the following briefly describes the accompanying drawings for describing the embodiments or the prior art. Clearly, the accompanying drawings in the following descriptions show merely some embodiments of the present application, and persons of ordinary skill in the art may still derive drawings of other embodiments from these accompanying drawings without creative efforts.

The accompanying drawings described herein are intended for better understanding of this application, and constitute a part of this application. Exemplary embodiments and descriptions thereof in this application are intended to interpret this application and do not constitute any improper limitation on this application.

FIG. 1 is a schematic diagram of a system architecture according to an embodiment of this application.

FIG. 2 is a detailed flowchart of surveillance terminal identification under a system architecture according to an embodiment of this application.

FIG. 3 is a schematic diagram of a scenario of performing monitoring on a data flow transmitted through a target port under a system architecture according to an embodiment of this application.

FIG. 4 is a schematic diagram of an N₁-th set of monitoring results obtained by performing monitoring on a data flow transmitted through a target port under a system architecture according to an embodiment of this application.

FIG. 5 is a detailed flowchart of obtaining a data feature vector according to an embodiment of this application.

FIG. 6 is a schematic diagram of data flow transformation during surveillance terminal identification according to an embodiment of this application.

FIG. 7 is a flowchart of surveillance terminal identification in an actual application scenario according to an embodiment of this application.

FIG. 8 is a schematic diagram of a scenario of surveillance terminal identification in an actual application scenario according to an embodiment of this application.

FIG. 9 is a schematic diagram of a scenario of surveillance terminal identification in another actual application scenario according to an embodiment of this application.

FIG. 10 is a schematic structural diagram of a surveillance terminal identification apparatus according to an embodiment of this application.

FIG. 11 is a schematic structural diagram of an electronic device according to an embodiment of this application.

FIG. 12 illustrates a feature submatrix.

### DESCRIPTION OF EMBODIMENTS

To make the objectives, technical solutions, and advantages of the embodiments of this application clearer, the following clearly and thoroughly describes the technical solutions of this application with reference to the accompanying drawings in the embodiments of this application. Apparently, the described embodiments are some but not all of the embodiments of this application. All other embodiments obtained by a person of ordinary skill in the art based on the embodiments described in this application document without creative efforts shall fall within the protection scope of the technical solutions of this application.

In the specification, claims, and accompanying drawings of this application, the terms “first” and “second” are used to distinguish between different objects, and not intended to describe a specific order. In addition, the term “include” and any other variant thereof are intended to cover non-exclusive protection. For example, a process, method, system, product, or device that includes a series of steps or units is not limited to the listed steps or units, but optionally further includes a step or unit unlisted, or optionally further includes another inherent step or unit of the process, method, product, or device. The term “a plurality of” in this application may mean at least two, for example, two, three, or more. However, the embodiments of this application are not limited thereto.

In addition, the term “and/or” in this specification describes only an association relationship for describing associated objects and represents that three relationships may exist. For example, A and/or B may represent the following three cases: Only A exists, both A and B exist, and only B exists. In addition, unless otherwise specified, the character “/” in this specification usually indicates an “or” relationship between associated objects.

In a surveillance scenario, too many network devices of a non-surveillance terminal type are associated, which will put great pressure on the egress bandwidth and network operation, thereby affecting the transmission of normal surveillance video data of the surveillance terminal. Therefore, how to efficiently and accurately recognize a surveillance terminal is a problem that every cloud management platform (also known as the cloud) needs to solve, which is of great significance to the development of network intelligent operation and maintenance based on terminal types.

At present, there are mainly the following ways for recognizing a surveillance terminal in the network in related art.

Way 1: Manual annotation is performed on surveillance terminals directly connected to each port of a switch through manual input by a deployer for the surveillance terminals.

Way 2: Corresponding network data rules are built for surveillance terminals produced by different manufacturers, and a surveillance terminal in the network is recognized through a corresponding network data rule.

Way 3: A surveillance terminal directly connected to a switch is recognized through an Open Network Video Interface Forum (ONVIF) protocol, and then Real Time Streaming Protocol (RTSP) packet data are obtained and analyzed to distinguish between IPC and NVR.

Way 4: Wireless network traffic in the network environment is obtained through a personal computer, and then classified and analyzed for features, and a wireless camera in the current environment is recognized based on the features of data flow of the wireless camera.

If Way 1 is used, input errors are prone to occur, and once a quantity of terminals in the network is too large, a large amount of manpower overhead will be generated.

If Way 2 is used, because the surveillance terminals from different vendors are deployed with different configurations, the features of their video stream network data are different. Therefore, it is necessary to build a corresponding expert rule for each manufacturer, each type, and each configuration of the surveillance terminal. As the terminal system is updated and upgraded, its expert rules also need to be continuously improved, which results in a large overhead to build and maintain a complete rule library.

If Way 3 is used, all packets in the switch are required to be detected and identified, which has certain requirements for the hardware performance of the switch and increases the processing pressure of the CPU carried by the switch itself. In addition, only a surveillance terminal that supports the ONVIF protocol can be recognized in this way. Although most surveillance terminals support the ONVIF protocol, they are usually disabled by default. For the surveillance terminals to be recognized, the ONVIF protocol needs to be manually enabled. Therefore, this way has certain limitations.

If Way 4 is used, only the wireless camera terminals in the network can be recognized, and the wired camera terminals cannot be recognized. However, most of the surveillance terminals in the surveillance network are wired surveillance terminals. and external devices are relied on to collect wireless traffic data in this way. Therefore, this way also has certain limitations.

A new surveillance-terminal identification method needs to be proposed for the foregoing problems.

The following describes some of the terms included in the embodiments of this application.

Classification model: Classification is one of the applications of machine learning. Classification models are used to learn according to existing data and labels and predict the labels of unknown data, and include binary classification models and multi-classification models. The binary classification means selecting one class from two classes. In a binary classification model, one class is called a positive class and another class is called a negative class. Multi-classification means selecting one class from multiple classes.

Decision tree: It is a basic classification model and uses a binary tree or a multi-way tree to represent the decision-making process. The root node of the tree contains the entire sample set, each leaf node corresponds to a decision result, and each internal node corresponds to one decision-making process.

Classification And Regression Tree (CART): It is a decision tree with a binary tree as a logical structure for linear regression tasks. It performs binary recursive segmentation and divides the sample space at each node. It has only two choices, yes or no, when making decisions at each step.

The following is a brief introduction to the design concept of the embodiments of this application.

IPC and NVR are surveillance terminals used in conjunction in the network. IPC is responsible for collecting surveillance videos, and then transmitting them to NVR through the switch. For the transmission of surveillance terminal video data from the IPC end to the NVR end, the whole process includes five stages: collection, encoding, transmission, decoding, and playback. The collection and encoding stages mainly occur at the IPC end, the transmission stage mainly occurs at the switch end, and the decoding and playback stages mainly occur at the NVR end.

The network traffic of the surveillance terminal in the transmission stage has obvious features. This is because the surveillance video data collected by the IPC needs to go through the encoding stage before it can be transmitted. The encoding protocol mainly used in the encoding stage is H.264. This protocol defines three types of frames: I-frame, B-frame, and P-frame. The I-frame represents a full key frame, which can be understood as the complete preservation of the image of this frame. The P-frame contains only information different from the previous frame and represents the difference between this frame and a previous key frame. During decoding, the previously cached image needs to be superimposed with the difference defined by this P-frame to generate the final image. The B-frame records the difference between this frame and the previous frame and the difference between this frame and the subsequent frame. To decode the B-frame, it is necessary to not only obtain the previously cached image, but also the decoded subsequent image. The final image of B-frame is obtained by superimposing the data of the previous image, the data of the subsequent image and the data of this B-frame. In the transmission stage, the data transmitted by the surveillance terminal are mainly in I-frame and P-frame. Therefore, the surveillance terminal has more stable network traffic than other terminals, has similar traffic distributions at different time points, and has certain periodicity. However, the traffic of non-surveillance terminals does not have this regularity.

In summary, a data flow transmitted through a port of a switch is obtained and analyzed for features, which can more accurately recognize whether a terminal directly connected to the port of the switch is a surveillance terminal.

The following describes in detail the embodiments of this application with reference to the accompanying drawings.

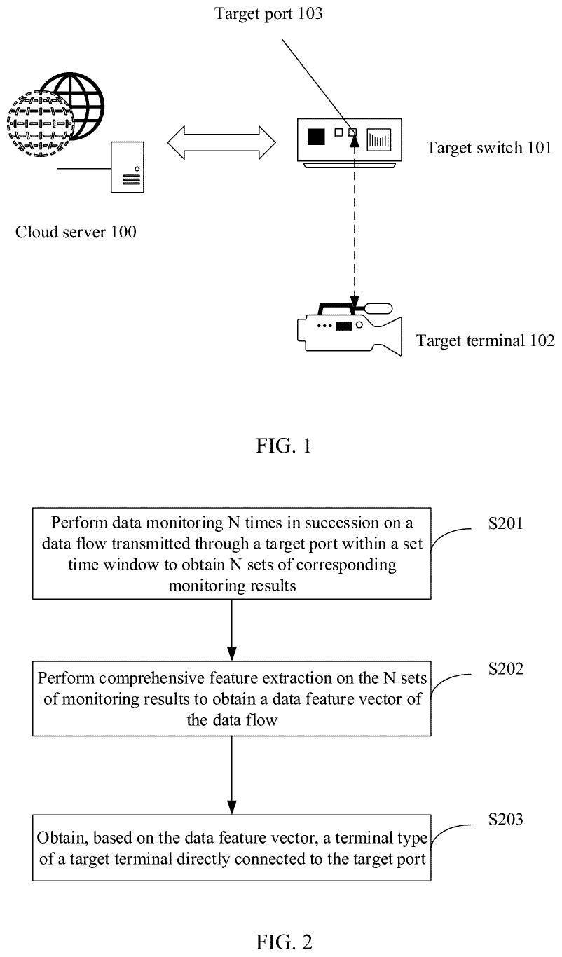

Referring to FIG. 1, in an embodiment of this application, there are three main parts: a cloud server 100, a target switch 101, and a target terminal 102. The target switch 101 transmits data with the target terminal 102 through a target port 103 of the target switch 101. An IPC identification model and an NVR identification model are deployed in the cloud server 100. When the cloud server 100 identifies whether a terminal type of the target terminal 102 is a surveillance terminal, it first performs data monitoring N times in succession on a data flow transmitted through the target port 103 based on a set time window to obtain N sets of monitoring results, where the monitoring result includes at least one status attribute of the data flow, and then performs comprehensive feature extraction on the N sets of monitoring results to obtain a data feature vector of the data flow, and finally inputs the data feature vector into the IPC identification model and/or the NVR identification model to obtain the terminal type of the target terminal 102 that is IPC or NVR of the surveillance terminal or another network device other than IPC and NVR. The cloud server 100 stores the terminal type of the target terminal 102 and the target port number of the target port 103 in a cloud database.

Based on the foregoing system architecture, referring to FIG. 2, in an embodiment of this application, a detailed flowchart of surveillance terminal identification is as follows.

One of ports of each network switch is selected as a target port first, and Step 201 is performed.

Step 201: Perform data monitoring N times in succession on a data flow transmitted through the target port within a set time window to obtain N sets of corresponding monitoring results.

Each set of monitoring results includes at least one traffic status attribute of the data flow. N is a positive integer.

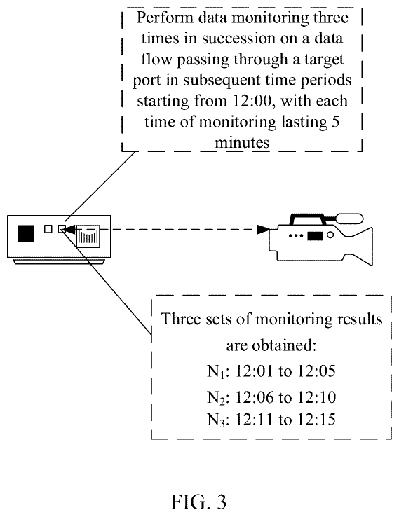

For example, referring to FIG. 3, given is the set time window being 5 minutes and N=3 (in this embodiment of this application, N≥3), the cloud server performs, based on the 5-minute set time window, data monitoring three times in succession on a data flow passing through the target port within the subsequent time period starting from 12:00, to obtain monitoring results within the three time period: N₁: 12:01 to 12:05, N₂: 12:06 to 12:10, and N₃: 12:11 to 12:15.

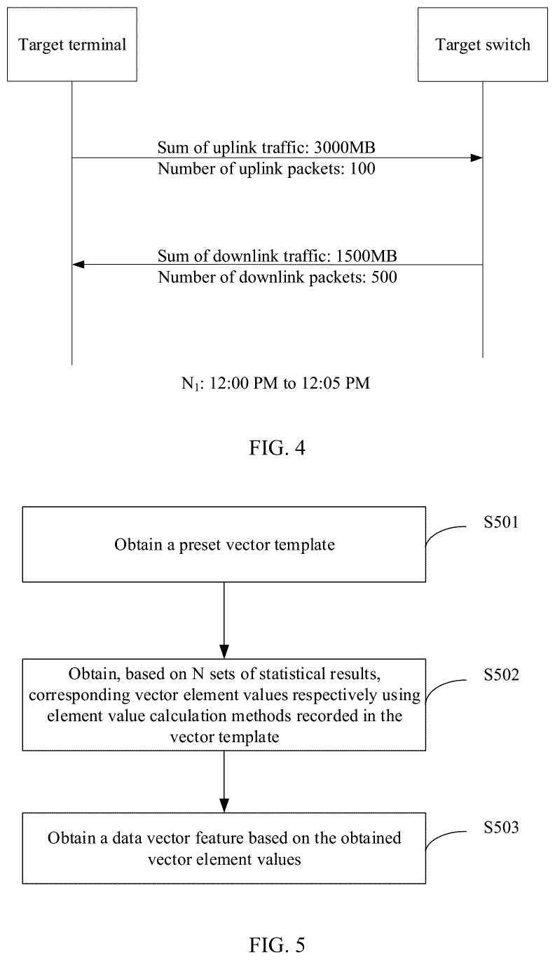

Specifically, in an embodiment of this application, each set of monitoring results includes: a sum of uplink traffic in a unit time window (a sum of uplink traffic for short), a sum of downlink traffic in a unit time window (a sum of downlink traffic for short), a quantity of uplink packets in a unit time window (a quantity of uplink packet for short), and a quantity of downlink packets in a unit time window (a quantity of downlink packet for short), totaling four traffic status attributes. For example, referring to FIG. 4, the unit time window refers to the 5-minute set time window, the sum of uplink traffic is 3000 MB, the quantity of uplink packets is 100, the sum of downlink traffic is 1500 MB, and the quantity of downlink packets is 500.

Step 202: Perform comprehensive feature extraction on the N sets of monitoring results to obtain a data feature vector of the data flow.

The data feature vector represents a traffic distribution of the data flow passing through the target port at different time points within N time windows.

Specifically, in an embodiment of this application, the data obtained in Step 201 is a monitoring result obtained based on aggregation within a unit time window. Therefore, to eliminate the influence of the aggregated monitoring result, before Step 202 is performed, the N sets of monitoring results need to be preprocessed, specifically including:
for each of the N sets of monitoring results, performing the following operations: determining a time period covered by a time window corresponding to one set of monitoring results, obtaining, based on the time period, a statistical parameter corresponding to at least one traffic status attribute of the data flow included in the one set of monitoring results, and using the obtained at least one statistical parameter as a statistical result corresponding to the one set of monitoring results.

Optionally, each set of statistical results includes but is not limited to the following data: an uplink rate, a downlink rate, a ratio of an uplink rate to a downlink rate, a unit uplink packet size, a unit downlink packet size, a ratio of a quantity of unit uplink packets to a quantity of unit downlink packets, and a ratio of a quantity of uplink packets to a quantity of downlink packets.

For example, referring to FIG. 4, it is assumed that within 5 minutes covered by a time window corresponding to the monitoring result N₁, the sum of uplink traffic is 3000 MB, a quantity of uplink packets is 100, the sum of downlink traffic is 1500 MB, and a quantity of downlink packets is 500, thus
the uplink rate is 3000 MB/(5 min×60 s)=10 MB/s;
the downlink rate is 1500 MB/(5 min×60 s)=5 MB/s;
the uplink and downlink rate ratio is (10 MB/s)/(5 MB/s)=2;
the unit uplink packet size is 3000/100=30 MB;
the unit downlink packet size is 1500/500=3 MB;
the ratio of the unit uplink packet size to the unit downlink packet size is 30/3=10; and
the ratio of the quantity of uplink packets to the quantity of downlink packets is 100/500=0.2.

The four traffic status attributes originally included in the N₁-th set of monitoring results are converted into seven statistical parameters to constitute a set of statistical results. Similarly, the calculation method of a set of statistical results for the N₂-th set of monitoring results is the same as that for the N₁-th set of statistical results, and the calculation method of a set of statistical results for the N₃-th set of monitoring results is the same as that for the N₁-th set of statistical results.

Given is Z representing output data in the current step, i representing the target terminal directly connected to the target port, and Zᵢ representing an output vector of the target terminal i after detection and preprocessing, at this point, the structure of the output vector Zᵢ is 7×N, where N=3.

Furthermore, in this embodiment of this application, referring to FIG. 5, the detailed process of obtaining a data feature vector of the data flow based on N sets of detection results after preprocessing, that is, the N sets of statistical results, is as follows.

Step 501: Obtain a preset vector template, where the vector template records element types of vector elements included in the data feature vector and an element value calculation method corresponding to each element type.

For example, the vector element values included in the data feature vector are an average value feature, a median value feature, a standard deviation feature, an interquartile range median ratio feature, and a coefficient of variation feature corresponding to each of the seven statistical parameters included in each set of statistical results, totaling five feature values. Thus, the vector template records the calculation methods of the five feature values corresponding to the seven statistical parameters, respectively.

In addition, it should be understood that Step 501 can also be performed before the N sets of monitoring results need to be preprocessed as mentioned above. The embodiments of this application do not make any limitations thereto.

Step 502: Obtain, based on N sets of statistical results, corresponding vector element values respectively using element value calculation methods recorded in the vector template.

For example, based on the uplink rates included in the N₁-th, N₂-th, and N₃-th sets of statistical results, their corresponding average value, median value, standard deviation, interquartile range median ratio, and coefficient of variation are calculated, respectively, as five vector element values of the data feature vector.

Step: 503: Obtain the data feature vector based on the obtained vector element values.

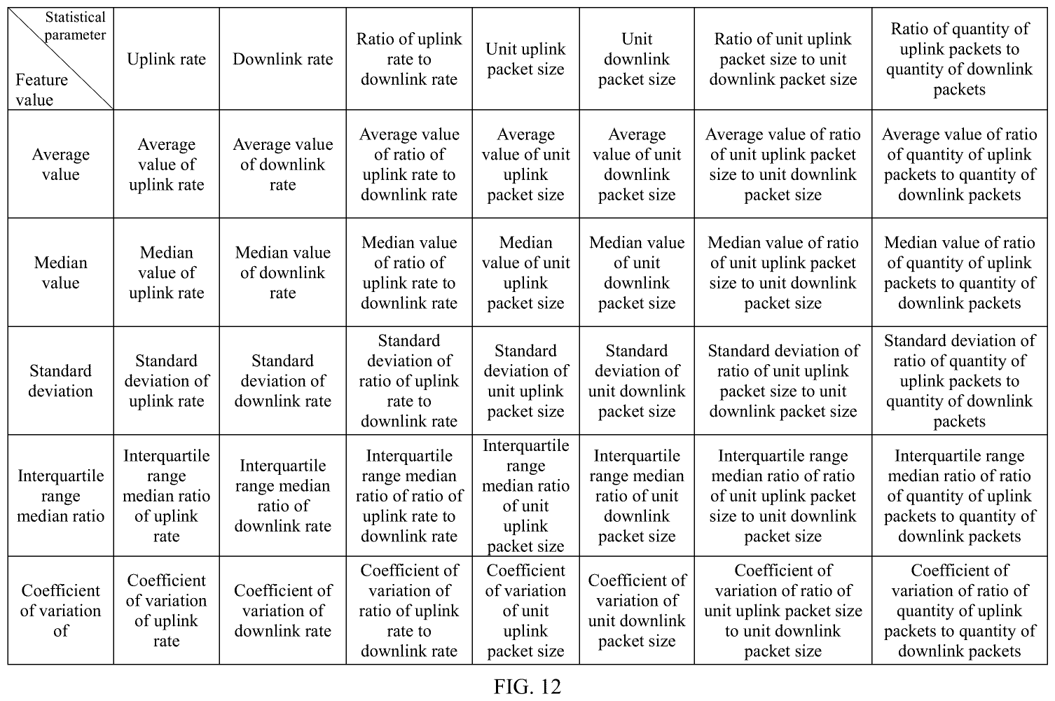

For example, the feature submatrix in FIG. 12 is obtained for the output vector Zᵢ.

At this point, the structure of the feature submatrix is 5×7. To simplify the format of the feature submatrix, the feature submatrix is serialized, so that the structure of the feature submatrix is transformed into 35×1. Given is X representing output data in the current step and Xᵢ representing a data feature vector of the target terminal i after feature extraction, at this point, the structure of the data feature vector Xᵢ is 35×1.

Step 203: Obtain, based on the data feature vector, a terminal type of a target terminal directly connected to the target port.

The direct connection mentioned in this embodiment of this application means that the data flow generated by the target terminal flows through the target port into the network switch to which the target port belongs, or the data flow received by the target terminal flows through the target port out of the network switch to which the target port belongs. It should be understood that in this embodiment of this application, the target terminal may be directly connected to the target port through a network cable, or may be connected through another network device. The embodiments of this application do not make any limitations thereto.

Specifically, in an embodiment of this application, the data feature vector is input into a pre-trained terminal type identification model to obtain a terminal type of the target terminal, where the terminal type identification model is obtained through training based on historical data flows transmitted through ports of various network switches and historical terminal types directly connected to the ports.

For example, in the cloud server, the IPC identification model and the NVR identification model are deployed, and output results of the two models are Y^{ipc} and Y^{nvr}, respectively.

Optionally, in an embodiment of this application, the terminal type of the target terminal is at least any one of the following:
an IPC of a surveillance terminal;
an NVR of the surveillance terminal; and
another network device other than the IPC and the NVR.

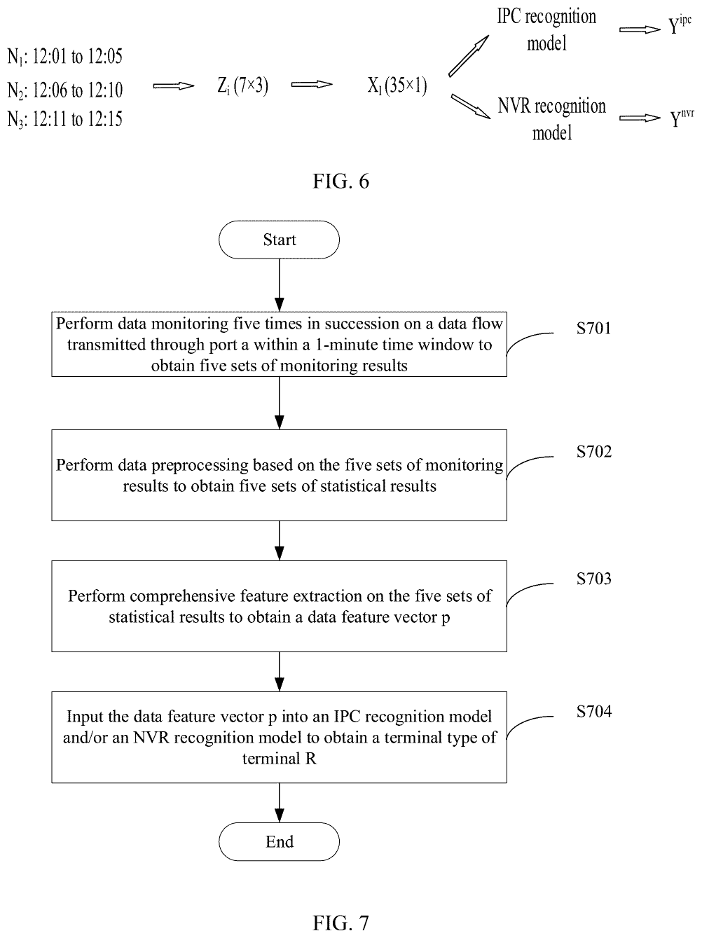

For example, for the transformation of data flow in an embodiment of this application, refer to FIG. 6. The cloud server first inputs the data feature vector Xᵢ into the IPC identification model to obtain the output result Yᵢ^{ipc}.

If Yᵢ^{ipc}≥0.5, it indicates that the target terminal i is an internet protocol camera of the surveillance terminal. In this case, NVR identification is no longer performed.

If Yᵢ^{ipc}<0.5, it indicates that the target terminal i is not an internet protocol camera of the surveillance terminal.

Furthermore, the cloud server inputs the data feature vector Xᵢ into the NVR identification model to obtain the output result Yᵢ^{nvr}.

If Yᵢ^{nvr}≥0.5, it indicates that the target terminal i is a network video recorder of the surveillance terminal.

If Yᵢ^{nvr}<0.5, it indicates that the target terminal i is not a network video recorder of the surveillance terminal.

If the output results of the two models are both less than 0.5, it indicates that the target terminal i is another network device other than IPC and NVR.

In another optional embodiment, the cloud server may alternatively input the data feature vector Xᵢ into the NVR identification model to obtain the output result Yᵢ^{nvr}.

If Yᵢ^{nvr}≥0.5, it indicates that the target terminal i is a network video recorder of the surveillance terminal. In this case, IPC identification is no longer performed.

If Yᵢ^{nvr}<0.5, it indicates that the target terminal i is not a network video recorder of the surveillance terminal.

Further, the cloud server inputs the data feature vector Xᵢ into the IPC identification model to obtain the output result Yᵢ^{ipc}.

If Yᵢ^{ipc}≥0.5, it indicates that the target terminal i is an internet protocol camera of the surveillance terminal.

If Yᵢ^{ipc}<0.5, it indicates that the target terminal i is not an internet protocol camera of the surveillance terminal.

If the output results of the two models are both less than 0.5, it indicates that the target terminal i is another network device other than IPC and NVR.

Optionally, in an embodiment of this application, after the terminal type of the target terminal directly connected to the target port is obtained through a pre-trained model, the method further includes: storing a target port number of the target port and the terminal type of the target terminal to a cloud database. Meanwhile, a serial number of a target switch to which the target port belongs and a MAC address of the target terminal are stored to the cloud database.

Based on the description of Step 203, the method of model identification can efficiently and accurately identify the surveillance terminal directly connected to the switch port, simplify the process of manually annotating the surveillance terminal, and solve the limitation of obtaining a terminal type based on ONVIF and RTSP packet data identification in the conventional method.

Optionally, the IPC identification model and the NVR identification model in an embodiment of this application are both Boosting Decision Tree (BDT) models, and belong to binary classification models in classification models. They mainly adopt the gradient boosting idea. Machine learning adopts a classification regression tree algorithm, and generates the final classification result by combining the results of a plurality of classification regression trees.

During training of the identification model, through actual investigation and business experience, it is confirmed that some switch ports are directly connected to the IPC or NVR of the surveillance terminal, and data flows transmitted through these switch ports that have been confirmed to be directly connected to the surveillance terminal are used as the training data of the identification model, that is, a training set.

For the data flow transmitted through the switch port in the training set, the cloud server performs data monitoring t (t≥3) times in succession on the data flow based on a set time window to obtain T sets of monitoring results, and obtains a data feature vector x based on the T sets of monitoring results according to the method described above.

The data flow of the surveillance terminal is more stable compared with data flows of other network terminals, and traffic distributions at different time points are similar and have certain periodicity. Therefore, in the data feature vector x, one or more of the average value feature, median value feature, standard deviation feature, interquartile range median ratio feature, and coefficient of variation feature are used to fit the traffic distribution of the switch port.

The coefficient of variation feature is defined as a ratio of the standard deviation to the average value. A lower value of the coefficient of variation feature indicates a more stable observed value. The interquartile range median ratio feature is defined as a ratio of the interquartile range to the median value, and it is mainly used to measure the degree of dispersion of the middle 50% data of the observed data.

Given is a size of the current training set being n, y^{ipc} representing an IPC surveillance terminal identifier, y^{nvr} representing an NVR surveillance terminal identifier, and r representing a terminal to be identified. An IPC identification sample is used as an example. If the terminal r to be identified is an internet protocol camera of the surveillance terminal, y^{ipc}=1, and data from this type of terminal becomes a positive sample. If the terminal r to be identified is not an internet protocol camera of the surveillance terminal, y^{ipc}=0, and data from this type of terminal becomes a negative sample. During identification model training, proportions of positive and negative samples should be as balanced as possible.

The training sample of the IPC identification model is (xᵣ, yr^{ipc}), and a training set composed of n training samples for training the IPC identification model is:

D^{ipc}={(xᵣ,yᵣ^{ipc})}(D^{ipc}=n).

Similarly, the training sample of the NVR identification model is (xᵣ, yᵣ^{nvr}), and a training set composed of n training samples for training the NVR identification model is:

D^{nvr}={(xᵣ,yᵣ^{nvr})}(D^{nvr}=n).

The training set D^{ipc} is used to train the IPC identification model, and the D^{nvr} is used to train the NVR identification model. The IPC model and the NVR model are trained in exactly the same way, except that they have different training targets y, and their model expressions can be uniformly described. The boosting decision tree model is expressed as the addition of K functions to predict the output, and the expression is:

$${y}_{r} = {\sum }_{k = 1}^{k} {f}_{k} ( {x}_{r} ) , {f}_{k} ∈ F$$

where yᵣ is a predicted value of each terminal type in the training set, and F is the space of classification and regression tree, which is specifically represented as:

$$F = \{ f ( x ) = {w}_{q ( x )} \} ( q : R \to T , w ∈ {R}^{T} )$$

where q represents the structure of each classification and regression tree, T is a quantity of leaf nodes in the tree, and each fₖ corresponds to an independent tree structure q and leaf node weight w.

The training set is used to learn, the tree structure q and weight w are continuously optimized, and a boosting decision tree model with high classification accuracy is trained and deployed to the cloud server for subsequent identification process. In addition, after a new terminal is connected to the network, a new identification model can be generated based on continuous optimization of the training set.

In summary, a boosting decision tree model used as the surveillance terminal identification model can not only flexibly process various data, but also has high prediction accuracy, and is easy to deploy and iteratively optimize in the cloud server.

The foregoing embodiments are further described in detail below through specific application scenarios.

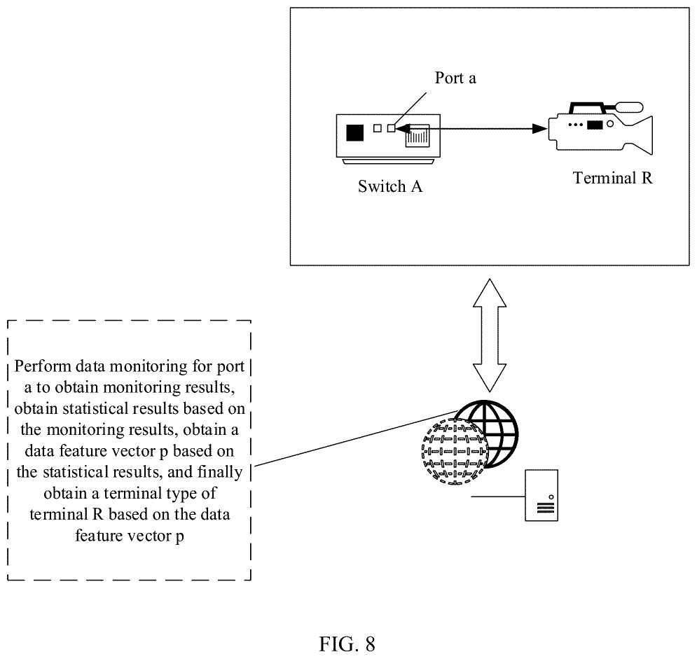

Scenario 1: Assuming that a new terminal R is newly connected to port a of switch A, referring to FIG. 7 and FIG. 8, a detailed process of performing surveillance terminal identification for terminal R by the cloud server is as follows.

Step 701: Perform data monitoring five times in succession on a data flow transmitted through port a within a 1-minute time window to obtain five sets of monitoring results, and then perform Step 702.

Step 702: Perform data preprocessing based on the five sets of monitoring results to obtain five sets of statistical results, and then perform Step 703.

Step 703: Perform comprehensive feature extraction on the five sets of statistical results to obtain a data feature vector p, and then perform Step 704.

Step 704: Input the data feature vector p into an IPC identification model and/or an NVR identification model to obtain a terminal type of terminal R.

The output result y_{R}^{ipc} of the IPC identification model is 0.8, indicating that the newly connected terminal R is an IPC. Therefore, the cloud server stores a serial number of switch A, a port number of port a, the terminal type of terminal R, and a MAC address of terminal R in the cloud database for subsequent operation, maintenance, and administration of terminal R.

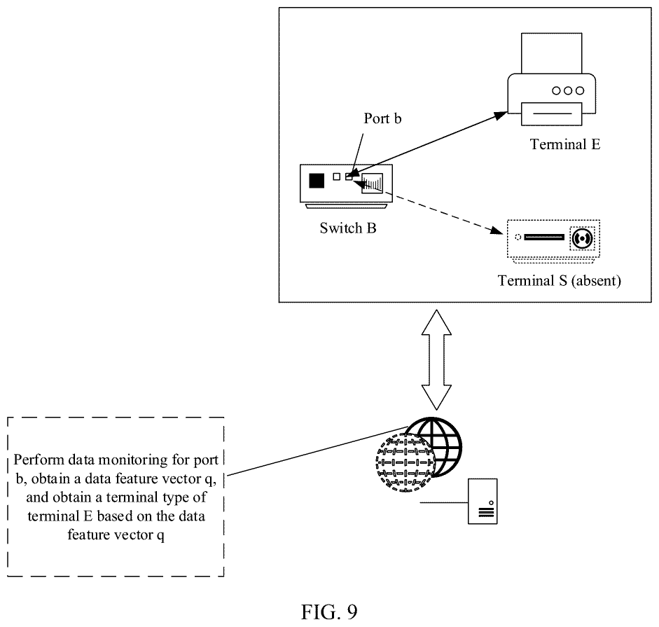

Scenario 2: Referring to FIG. 9, assuming that a terminal S directly connected to port b of a switch B being an NVR, which is recorded in the cloud database, but it is found through querying that a MAC address of the terminal S no longer exists, indicating that a terminal connected to port b is no longer the terminal S. Assuming that the latest terminal connected to port b is terminal E, at this point, the cloud server performs terminal type identification for it. The specific performing steps are similar to those in Scenario 1.

After detecting, by the cloud server, the data flow through the port b and obtaining a data feature vector q, the cloud server inputs the data feature vector q into the IPC identification model and/or the NVR identification model. If the obtained output results y_{E}^{ipc} and y_{E}^{nvr} are both less than 0.5, it indicates that the terminal E is another network device other than IPC and NVR. Therefore, the cloud server deletes the serial number of switch B, the port number of port b, the terminal type of terminal S, and the MAC address of terminal S from the cloud database.

In addition, although the operations of the method of this application are described in a specific order in the accompanying drawings, this does not require or imply that these operations must be performed in that specific order, or that all the operations shown must be performed to achieve the desired result. Additionally or alternatively, some steps may be omitted, multiple steps may be combined into one step, and/or one step may be decomposed into multiple steps.

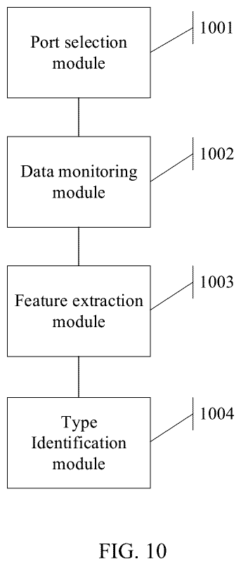

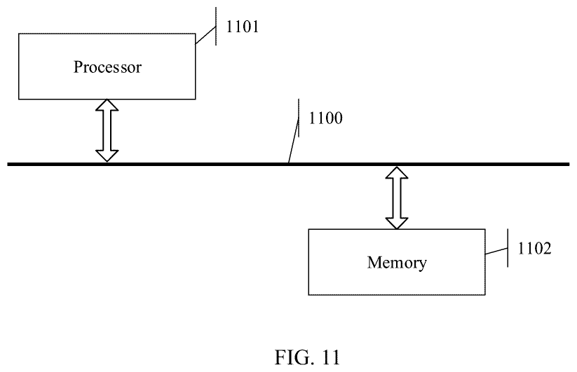

Based on the same technical concept, referring to FIG. 10, an embodiment of this application further provides a surveillance-terminal identification apparatus, where the apparatus includes:
a port selection module 1001, configured to determine a target port, where the target port is any one of ports of various network switches;
a data monitoring module 1002, configured to perform data monitoring N times in succession on a data flow transmitted through the target port within a set time window to obtain N sets of corresponding monitoring results, where each set of monitoring results includes at least one traffic status attribute of the data flow;
a feature extraction module 1003, configured to perform comprehensive feature extraction on the N sets of monitoring results to obtain a data feature vector of the data flow, where the data feature vector represents a traffic distribution of the data flow passing through the target port at different time points within N time windows; and
a type identification module 1004, configured to obtain, based on the data feature vector, a terminal type of a target terminal directly connected to the target port.

Optionally, in the step of performing comprehensive feature extraction on the N sets of monitoring results to obtain a data feature vector of the data flow, the feature extraction module 1003 is configured to:
obtain a preset vector template, where the vector template records element types of vector elements included in the data feature vector and an element value calculation method corresponding to each element type;
obtain, based on N sets of monitoring results, corresponding vector element values respectively using element value calculation methods recorded in the vector template; and
obtain the data feature vector based on the obtained vector element values.

Optionally, in the step of obtaining, based on N sets of monitoring results, corresponding vector element values respectively using element value calculation methods recorded in the vector template, the feature extraction module 1003 is configured to:
for each of the N sets of monitoring results, perform the following operations: determining a time period covered by a time window corresponding to one set of monitoring results, obtaining, based on the time period, a statistical parameter corresponding to at least one traffic status attribute of the data flow included in the one set of monitoring results, and using the obtained at least one statistical parameter as a statistical result corresponding to the one set of monitoring results; and
obtain, based on obtained N sets of statistical results, corresponding vector element values respectively using element value calculation methods recorded in the vector template.

Optionally, in the step of obtaining, based on the data feature vector, a terminal type of a target terminal directly connected to the target port, the type identification module 1004 is configured to:
input the data feature vector into a pre-trained terminal type identification model to obtain a terminal type of the target terminal, where the terminal type identification model is obtained through training based on historical data flows transmitted through ports of network switches and historical terminal types directly connected to the ports.

Optionally, after obtaining a terminal type of a target terminal directly connected to the target port, the type identification module 1004 is further configured to:
store a target port number of the target port and the terminal type of the target terminal to a cloud database.

Optionally, the terminal type of the target terminal is at least any one of the following:
an IPC of a surveillance terminal;
an NVR of the surveillance terminal; and
another network device other than the IPC and the NVR.

Based on the same technical concept, an embodiment of this application further provides an electronic device, where the electronic device can implement the method flow of surveillance-terminal identification according to the foregoing embodiment of this application.

In an embodiment, the electronic device may be a server, or may be a terminal device or another electronic device.

Referring to FIG. 11, the electronic device may include:

at least one processor 1101 and a memory 1102 connected to the at least one processor 1101. Specific connection medium between the processor 1101 and the memory 1102 is not limited in this embodiment of this application. In FIG. 11, for example, the processor 1101 and the memory 1102 are connected via a bus 1100. The bus 1100 is represented by a bold line in FIG. 11. A connection manner between other components is described merely as an example and does not constitute a limitation. The bus 1100 may be classified into an address bus, a data bus, a control bus, and the like. For ease of representation, only one bold line is used to represent the bus in FIG. 11, but this does not mean that there is only one bus or only one type of bus. Alternatively, the processor 1101 may also be referred to as a controller, without limitation to the name.

In this embodiment of this application, the memory 1102 stores an instruction that can be executed by the at least one processor 1101, and the at least one processor 1101 may perform, by executing the instruction stored in the memory 1102, the foregoing surveillance-terminal identification method. The processor 1101 can implement the functions of various modules in the apparatus shown in FIG. 10.

The processor 1101 is a control center of the apparatus, may use various interfaces and lines to connect various parts of the entire control device, and execute various functions and data processing of the apparatus by running or executing the instruction stored in the memory 1102 and invoking data stored in the memory 1102, so as to perform overall surveillance on the apparatus.

In a possible design, the processor 1101 may include one or more processing units. The processor 1101 may integrate an application processor and a modem processor. The application processor mainly processes the operating system, a user interface, an application program, and the like. The modem processor mainly processes wireless communication. It can be understood that the modem processor may alternatively be not integrated in the processor 1101. In some embodiments, the processor 1101 and the memory 1102 may be implemented on a same chip. In some embodiments, the processor 1101 and the memory 1102 may also be implemented separately on separate chips.

The processor 1101 may be a general-purpose processor, for example, CPU, a digital signal processor, an application-specific integrated circuit, a field programmable gate array or another programmable logic device, a discrete gate or a transistor logic device, or a discrete hardware component, and may implement or perform the methods, steps, and logical block diagrams disclosed in the embodiments of this application. The general-purpose processor may be a microprocessor or any conventional processor or the like. Steps of the surveillance-terminal identification method disclosed with reference to the embodiments of this application may be directly performed and completed by using a hardware processor, or may be performed and completed by using a combination of hardware in the processor and a software module.

As a non-volatile computer-readable storage medium, the memory 1102 may be configured to store non-volatile software programs, non-volatile computer-executable programs, and modules. The memory 1102 may include at least one type of storage medium, for example, may include a flash memory, a hard disk, a multimedia card, a memory card, a Random Access Memory (RAM), a Static Random Access Memory (SRAM), a Programmable Read-Only Memory PROM), a Read-Only Memory (ROM), an Electrically Erasable Programmable Read-Only Memory (EEPROM), a magnetic memory, a magnetic disk, an optical disk, or the like. The memory 1102 is but not limited to any other medium that can be used to carry or store desired program code in a form of an instruction or a data structure and can be accessed by a computer. The memory 1102 in the embodiments of this application may alternatively be a circuit or any other apparatus that can implement a storage function, and is configured to store a program instruction and/or data.

Code corresponding to the surveillance-terminal identification method in the foregoing embodiments is incorporated into a chip by designing and programming the processor 1101, so that when the chip runs, the steps of the surveillance-terminal identification method in FIG. 2 can be performed. How to design and program the processor 1101 is a technology well known by a person skilled in the art. Details are not described herein.

Based on the same inventive concept, an embodiment of this application further provides a storage medium. The storage medium stores a computer instruction. When the computer instruction is run on a computer, the computer is enabled to perform the steps of the foregoing surveillance-terminal identification method.

In some possible implementations, various aspects of the surveillance-terminal identification method provided in this application may be further implemented in a form of a program product, which includes program code. When the program product runs on an apparatus, the program code is used to enable the control device to perform the steps of the foregoing surveillance-terminal identification method according to various exemplary embodiments of this application described in the specification.

It should be noted that although several units or subunits of the apparatus are mentioned in the foregoing detailed description, such division is only exemplary and not mandatory. Indeed, according to the embodiments of this application, the features and functions of two or more units described above can be embodied in one unit. Conversely, the features and functions of one unit described above can be further divided into multiple units for embodiment.

In addition, although the operations of the method of this application are described in a specific order in the accompanying drawings, this does not require or imply that these operations must be performed in that specific order, or that all the operations shown must be performed to achieve the desired result. Additionally or alternatively, some steps may be omitted, multiple steps may be combined into one step, and/or one step may be decomposed into multiple steps.

This application is described with reference to the flowcharts and/or the block diagrams of the method, the device (system), and the computer program product according to the embodiments of this application. It should be understood that computer program instructions may be used to implement each procedure and/or each block in the flowcharts and/or the block diagrams and a combination of a procedure and/or a block in the flowcharts and/or the block diagrams. These computer program instructions may be provided to a general-purpose computer, a special-purpose computer, an embedded processor, or a processor of another programmable data processing device to generate a machine, so that the instructions executed by the computer or the processor of the another programmable data processing device generate an apparatus for implementing a specific function in one or more processes in the flowcharts and/or one or more blocks in the block diagrams.

These computer program instructions may be stored in a computer-readable memory that can instruct the computer or the another programmable data processing device to work in a specific manner, so that the instructions stored in the computer-readable memory generate an artifact that includes an instruction apparatus. The instruction apparatus implements a specific function in one or more processes in the flowcharts and/or one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or another programmable device provide steps for implementing a specific function in one or more processes in the flowcharts and/or one or more blocks in the block diagrams.

Although optional embodiments of this application have been described, persons skilled in the art may make additional changes and modifications to these embodiments once they learn the basic inventive concept. Therefore, the appended claims shall be construed to cover the optional embodiments and various changes and modifications falling within the scope of the embodiments of this application.

Apparently, a person skilled in the art may make various changes and variations to the embodiments of this application without departing from the spirit and scope of the embodiments of this application. Therefore, the embodiments of this application are also intended to cover the changes and variations provided that the changes and variations of this application fall within the scope of the claims of this application or equivalent technologies thereof.

What is claimed is:

1. A surveillance-terminal identification method, comprising:
determining a target port, wherein the target port is one of a plurality of ports of a network switch;
performing data monitoring N times in succession on a data flow transmitted through the target port within N set time windows to obtain N sets of corresponding monitoring results, wherein each set of monitoring results comprises at least one traffic status attribute of the data flow, and N is a positive integer;
performing comprehensive feature extraction on the N sets of monitoring results to obtain a data feature vector of the data flow, wherein the data feature vector represents a traffic distribution of the data flow passing through the target port at different time points within the N time windows; and
obtaining, based on the data feature vector, a terminal type of a target terminal directly connected to the target port.

2. The method according to claim 1, wherein the performing comprehensive feature extraction on the N sets of monitoring results to obtain the data feature vector of the data flow comprises:
obtaining a preset vector template, wherein the vector template is used to indicate element types corresponding to a plurality of vector elements comprised in the data feature vector and an element value calculation method corresponding to each element type;
obtaining, based on the N sets of monitoring results, a plurality of corresponding vector element values respectively using the plurality of element value calculation methods indicated by the vector template; and
obtaining the data feature vector based on the obtained plurality of vector element values.

3. The method according to claim 2, wherein the obtaining, based on the N sets of monitoring results, the plurality of corresponding vector element values respectively using the plurality of element value calculation methods indicated by the vector template comprises:
obtaining N sets of statistical results based on the N sets of monitoring results; and
obtaining the corresponding vector element values for the obtained N sets of statistical results, respectively using the element value calculation methods recorded in the vector template.

4. The method according to claim 3, wherein the obtaining the N sets of statistical results based on the N sets of monitoring results comprises:
determining a time period covered by a time window corresponding to one of the N sets of monitoring results;
obtaining, based on the time period, at least one statistical parameter corresponding to at least one traffic status attribute of a data flow comprised in the one set of monitoring results; and
using the obtained at least one statistical parameter as the statistical result corresponding to the one set of monitoring results.

5. The method according to claim 4, wherein each set of monitoring results comprises: a sum of uplink traffic in a unit time window, a sum of downlink traffic in a unit time window, a quantity of uplink packets in a unit time window, and a quantity of downlink packets in a unit time window.

6. The method according to claim 5, wherein the statistical result comprises at least one of the following: an uplink rate, a downlink rate, a ratio of an uplink rate to a downlink rate, a unit uplink packet size, a unit downlink packet size, a ratio of the unit uplink packet size to the unit downlink packet size, and a ratio of a quantity of uplink packets to a quantity of downlink packets.

7. The method according to claim 2, wherein the vector element value comprises at least one of the following: an average value feature, a median value feature, a standard deviation feature, an interquartile range median ratio feature, and a coefficient of variation feature.

8. The method according to claim 1, wherein the obtaining, based on the data feature vector, the terminal type of the target terminal directly connected to the target port comprises:
inputting the data feature vector into a pre-trained terminal type identification model to obtain a terminal type of the target terminal, wherein the terminal type identification model is obtained through training based on historical data flows transmitted through a plurality of ports of a plurality of network switches and historical terminal types directly connected to the plurality of ports.

9. The method according to claim 8, wherein the terminal type identification model comprises an internet protocol camera IPC identification model and a network video recorder NVR identification model.

10. The method according to claim 8, wherein the inputting the data feature vector into the pre-trained terminal type identification model to obtain the terminal type of the target terminal comprises:
inputting the data feature vector into the IPC identification model to obtain an output result Yᵢ^{ipc}; and
in response to Yᵢ^{ipc} being greater than or equal to a first threshold, determining that the terminal type of the target terminal is an internet protocol camera of a surveillance terminal.

11. The method according to claim 10, wherein after the output result Yᵢ^{ipc} is obtained, the method further comprises:
in response to Yᵢ^{ipc} being less than the first threshold, inputting the data feature vector into the NVR identification model to obtain an output result Yᵢ^{nvr}; and
in response to Yᵢ^{nvr} being greater than or equal to the first threshold, determining that the terminal type of the target terminal is a network video recorder of the surveillance terminal.

12. The method according to claim 11, wherein after the output result Yᵢ^{nvr} is obtained, the method further comprises:
in response to Yᵢ^{nvr} being less the first threshold, determining that the terminal type of the target terminal is another network device other than IPC and NVR.

13. The method according to claim 9, wherein the terminal type identification model is a boosting decision tree model.

14. The method according to claim 1, wherein after the obtaining the terminal type of the target terminal directly connected to the target port, the method further comprises:
storing a target port number of the target port and the terminal type of the target terminal to a cloud database.

15. The method according to claim 14, wherein after the storing the target port number of the target port and the terminal type of the target terminal to a cloud database, the method further comprises:
storing a serial number of the network switch and a MAC address of the target terminal to the cloud database.

16. The method according to claim 1, wherein the terminal type of the target terminal is one of the following:
an internet protocol camera IPC of a surveillance terminal;
a network video recorder NVR of the surveillance terminal; and
another network device other than the IPC and the NVR.

17. An electronic device, comprising a memory, a processor, and a computer program stored in the memory and capable of running on the processor, wherein when the processor executes the computer program, a surveillance-terminal identification method is implemented, wherein the method comprises:
determining a target port, wherein the target port is one of a plurality of ports of a network switch;
performing data monitoring N times in succession on a data flow transmitted through the target port within N set time windows to obtain N sets of corresponding monitoring results, wherein each set of monitoring results comprises at least one traffic status attribute of the data flow, and N is a positive integer;
performing comprehensive feature extraction on the N sets of monitoring results to obtain a data feature vector of the data flow, wherein the data feature vector represents a traffic distribution of the data flow passing through the target port at different time points within the N time windows; and
obtaining, based on the data feature vector, a terminal type of a target terminal directly connected to the target port.

18. The electronic device according to claim 17, wherein the performing comprehensive feature extraction on the N sets of monitoring results to obtain the data feature vector of the data flow comprises:
obtaining a preset vector template, wherein the vector template is used to indicate element types corresponding to a plurality of vector elements comprised in the data feature vector and an element value calculation method corresponding to each element type;
obtaining, based on the N sets of monitoring results, a plurality of corresponding vector element values respectively using the plurality of element value calculation methods indicated by the vector template; and
obtaining the data feature vector based on the obtained plurality of vector element values.

19. A non-transitory computer-readable storage medium storing a computer program thereon, wherein when the computer program is executed by a processor, a surveillance-terminal identification method is implemented, wherein the method comprises:
determining a target port, wherein the target port is one of a plurality of ports of a network switch;
performing data monitoring N times in succession on a data flow transmitted through the target port within N set time windows to obtain N sets of corresponding monitoring results, wherein each set of monitoring results comprises at least one traffic status attribute of the data flow, and N is a positive integer;
performing comprehensive feature extraction on the N sets of monitoring results to obtain a data feature vector of the data flow, wherein the data feature vector represents a traffic distribution of the data flow passing through the target port at different time points within the N time windows; and
obtaining, based on the data feature vector, a terminal type of a target terminal directly connected to the target port.

20. The medium according to claim 19, wherein the performing comprehensive feature extraction on the N sets of monitoring results to obtain the data feature vector of the data flow comprises:
obtaining a preset vector template, wherein the vector template is used to indicate element types corresponding to a plurality of vector elements comprised in the data feature vector and an element value calculation method corresponding to each element type;
obtaining, based on the N sets of monitoring results, a plurality of corresponding vector element values respectively using the plurality of element value calculation methods indicated by the vector template; and
obtaining the data feature vector based on the obtained plurality of vector element values.
